(19) United States
(12) Patent Application Publication
(10) Pub. No.: US 2002/0097859 A1
(43) Pub. Date: Jul. 25, 2002

(54) Communication peripheral apparatus automatic line searcher

(76) Inventor: Hsin Wu Lee, Chung Ho City (TW)

Correspondence Address: BACON & THOMAS, PLLC, 625 Slaters Lane - 4th Floor, Alexandria, VA, 22314-1176, US

(21) Appl. No.: 09/764,460

(22) Filed: Jan. 19, 2001

(51) Int. Cl. H04M 3/00; H04M 1/00

(52) U.S. Cl. 379/385; 379/377

(57) ABSTRACT

A communication peripheral apparatus automatic line searcher includes a CPU (central processing unit) connected to two ring detectors, two hold detectors, two in-use detectors and a loop detector, the ring detectors, hold detectors and in-use detectors being respectively connected to a first telephone line and a second telephone line, the first telephone line and the second telephone line being respectively connected to contacts of a first relay, the first relay having a center contact connected to the normal-close contact of a second relay. The CPU automatically switches the vacant telephone to the vacant telephone line upon a call through one telephone line. The relays are switched to drive the phone power through the CPU to indicate the in-use status of the corresponding telephone line.

### BACKGROUND OF THE INVENTION

The present invention relates to a communication peripheral apparatus automatic line searcher, which automatically detects the hold/in-use status of telephone lines, and automatically indicates the line-busy status of the telephone line in use.

When multiple telephone lines are used, a switching machine may be installed to automatically switch the telephone lines. A switching machine for this purpose is heavy and expensive, not economic for double-telephone line home use. There is a strong demand for an inexpensive telephone line switching apparatus adapted for home use.

### SUMMARY OF THE INVENTION

The present invention has been accomplished under the circumstances in view. It is one object of the present invention to provide a communication peripheral apparatus automatic line searcher, which automatically detects the hold/in-use status of telephone lines, and automatically indicates the line-busy status of the telephone line in use. It is another object of the present invention to provide a communication peripheral apparatus automatic line searcher, which is inexpensive to manufacture. The communication peripheral apparatus automatic line searcher uses a CPU to control the operation of ring detectors, hold detectors and in-use detectors to detect the status of two telephone lines, and a loop detector to indicate the line busy status of the telephone been occupied.

### BRIEF DESCRIPTION OF THE DRAWINGS

The invention will now be described by way of examples, with reference to the annexed drawings, in which:

FIG. 1 is a circuit block diagram of the present invention.

### DETAILED DESCRIPTION OF THE PREFERRED EMBODIMENT

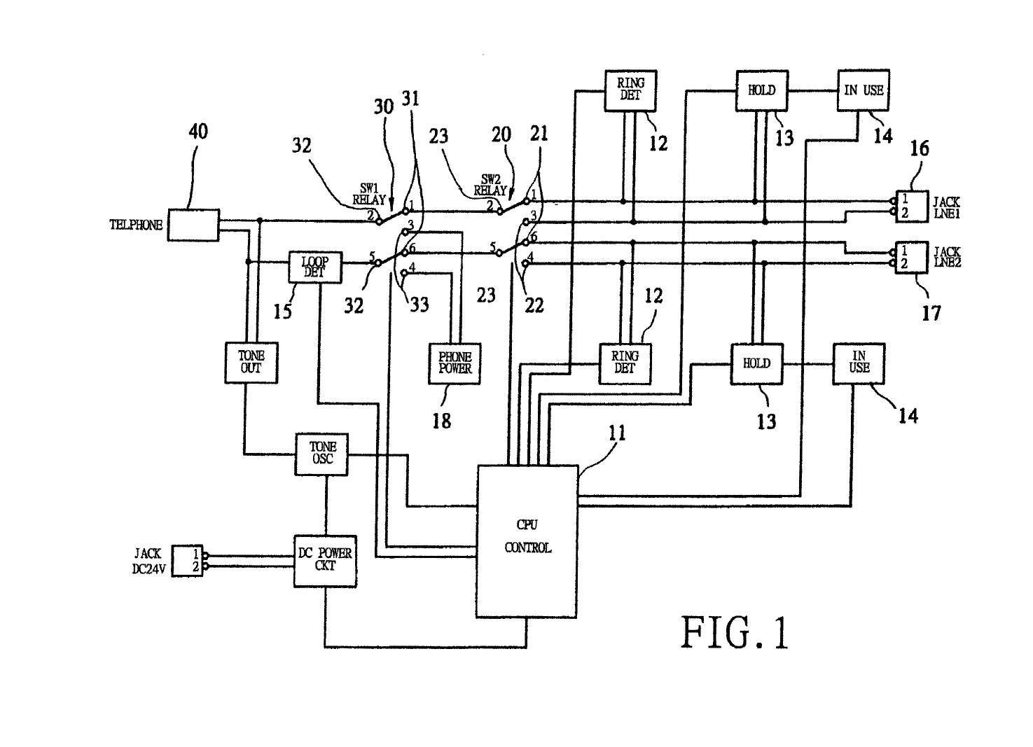

Referring to FIGS. 1, a communication peripheral apparatus automatic line searcher in accordance with the present invention comprises a CPU 11 connected to two ring detectors 12, two hold detectors 13, two in-use detectors 14, and a loop detector 15. The ring detectors 12, hold detectors 13 and in-use detectors 14 are respectively connected to jack line 1 16 and jack line 2 17. The jack line 1 16 and the jack line 2 17 are respectively connected to contacts 21 and 22 of a first relay 20. The center contact 23 of the first relay 20 is connected to the normal-close contact 31 of a second relay 30. The center contact 32 of the second relay 30 is connected to the telephone 40 and the loop detector 15. The control contacts of the relays 20 and 30 are respectively connected to the CPU 11. The normal-open contact 33 of the second relay 30 is connected to a phone power 18.

When a call enters the jack line 1 16 or the jack line 2 17, the ring signal is detected by the corresponding ring detector 12. After the user picked up the telephone 40, the relays 20 and 30 are automatically switched to the other vacant jack line. When another telephone selects the same jack line, the hold detectors 13 and the in-use detectors 14 detect the status of the jack lines 16 and 17 and give the detection result to the CPU 11, causing the CPU 11 to drive the phone power 18 to give an indication of the in-use status of the corresponding jack line.

It is to be understood that the drawings are designed for purposes of illustration only, and are not intended for use as a definition of the limits and scope of the invention disclosed.

What the invention claimed is:

1. A communication peripheral apparatus automatic line searcher comprising a CPU (central processing unit) connected to two ring detectors, two hold detectors, two in-use detectors and a loop detector, said ring detectors, hold detectors and in-use detectors being respectively connected to a first telephone line and a second telephone line, said first telephone line and said second telephone line being respectively connected to contacts of a first relay, said first relay having a center contact connected to the normal-close contact of a second relay.

2. The of claim 1, wherein said second relay has a normal-open contact connected to a phone power for line busy indication.
